(19) United States
(12) Patent Application Publication
(10) Pub. No.: US 2026/0353501 A1
(43) Pub. Date: Nov. 5, 2026

(54) CONDITIONAL LTM TIMING ADVANCED TIMER HANDLING

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/537,232

(22) Filed: Feb. 11, 2026

Related U.S. Application Data
(60) Provisional application No. 63/767,333, filed on Mar. 5, 2025.
(60) Provisional application No. 63/768,264, filed on Mar. 7, 2025.
(60) Provisional application No. 63/799,897, filed on May 5, 2025.

(51) Int. Cl. H04W 76/27; H04W 36/00; H04W 72/23

(52) U.S. Cl. CPC H04W 76/27; H04W 36/0072; H04W 72/23

(57) ABSTRACT

A method of operating a user equipment (UE) includes determining a first determination that (i) a conditional layer 1 (L1)/layer 2 (L2) triggered mobility (LTM) cell switch procedure for an LTM candidate cell is triggered, and (ii) an LTM candidate time alignment timer (ltm-Candidate-TimeAlignmentTimer) associated with the LTM candidate cell is running. The method also includes, in response to the first determination, applying a stored timing advance (TA) value associated with the LTM candidate cell for a primary timing advance group (PTAG), and starting a time alignment timer (timeAlignmentTimer) associated with the PTAG with a timer value equal to a remaining value of the running ltm-Candidate-TimeAlignmentTimer associated with the LTM candidate cell.

### CROSS-REFERENCE TO RELATED APPLICATION(S) AND CLAIM OF PRIORITY

This application claims priority under 35 U.S.C. § 119(e) to U.S. Provisional Patent Application No. 63/767,333 filed on Mar. 5, 2025, U.S. Provisional Patent Application No. 63/768,264 filed on Mar. 7, 2025, and U.S. Provisional Patent Application No. 63/799,897 filed on May 5, 2025. The above-identified provisional patent applications are hereby incorporated by reference in their entirety.

### TECHNICAL FIELD

This disclosure relates generally to wireless networks. More specifically, this disclosure relates to conditional layer 1 (L1)/layer 2 (L2) triggered mobility (LTM) timing advance (TA) timer handling.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for conditional LTM TA timer handling.

In one embodiment, a method of operating a user equipment (UE) is provided. The method includes determining a first determination that (i) a conditional layer 1 (L1)/layer 2 (L2) triggered mobility (LTM) cell switch procedure for an LTM candidate cell is triggered, and (ii) an LTM candidate time alignment timer (ltm-Candidate-TimeAlignmentTimer) associated with the LTM candidate cell is running. The method also includes, in response to the first determination, applying a stored timing advance (TA) value associated with the LTM candidate cell for a primary timing advance group (PTAG), and starting a time alignment timer (timeAlignmentTimer) associated with the PTAG with a timer value equal to a remaining value of the running ltm-Candidate-TimeAlignmentTimer associated with the LTM candidate cell.

In another embodiment, an electronic device is provided. The electronic device includes at least one processor including processing circuitry, and memory storing instructions. The instructions, when executed by the at least one processor individually or collectively, cause the electronic device to determine a first determination that (i) a conditional LTM cell switch procedure for an LTM candidate cell is triggered, and (ii) an ltm-Candidate-TimeAlignmentTimer associated with the LTM candidate cell is running. The instructions, when executed by the at least one processor individually or collectively, also cause the electronic device to, in response to the first determination, apply a stored TA value associated with the LTM candidate cell for a PTAG, and start a timeAlignmentTimer associated with the PTAG with a timer value equal to a remaining value of the running ltm-Candidate-TimeAlignmentTimer associated with the LTM candidate cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example NG-RAN overall architecture according to embodiments of the present disclosure;

FIG. 4B illustrates an example architecture for gNB-CU-CP and gNB-CU-UP separation according to embodiments of the present disclosure;

FIG. 5 illustrates example signaling procedures for inter-gNB handover according to embodiments of the present disclosure;

FIG. 6 illustrates an example procedure for LTM according to embodiments of the present disclosure;

FIG. 7 illustrates an example procedure for ltm-Candidate-TimeAlignmentTimer handling according to embodiments of the present disclosure;

FIG. 8 illustrates another example procedure for ltm-Candidate-TimeAlignmentTimer handling according to embodiments of the present disclosure;

FIG. 9 illustrates an example LTM based mobility procedure according to embodiments of the present disclosure; and

FIG. 10 illustrates an example method for conditional LTM TA timer handling according to embodiments of the present disclosure.

### DETAILED DESCRIPTION

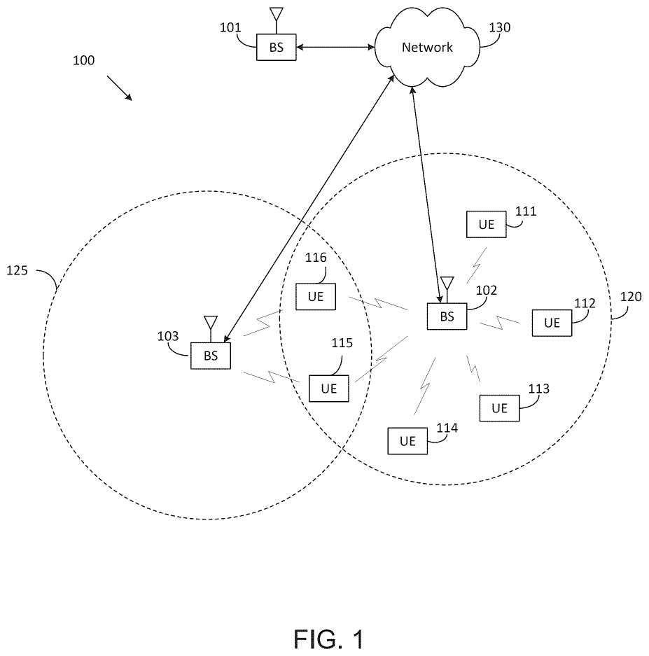

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for conditional LTM TA timer handling. In certain embodiments, one or more of the gNBs 101-103 includes circuitry, programing, or a combination thereof, to support conditional LTM TA timer handling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

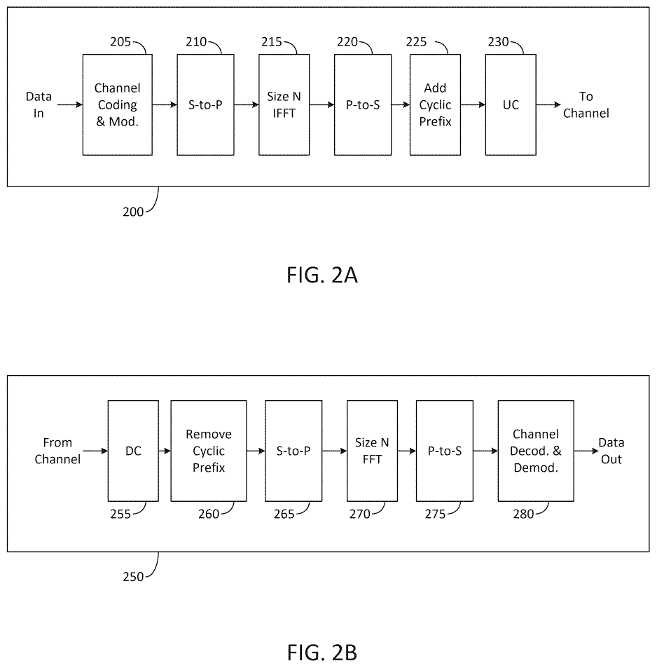

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support conditional LTM TA timer handling as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

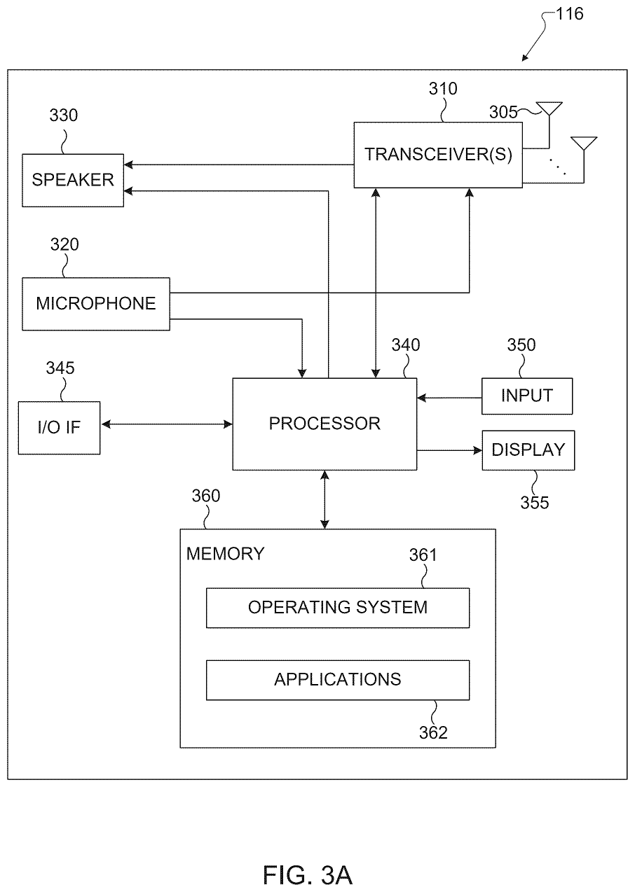

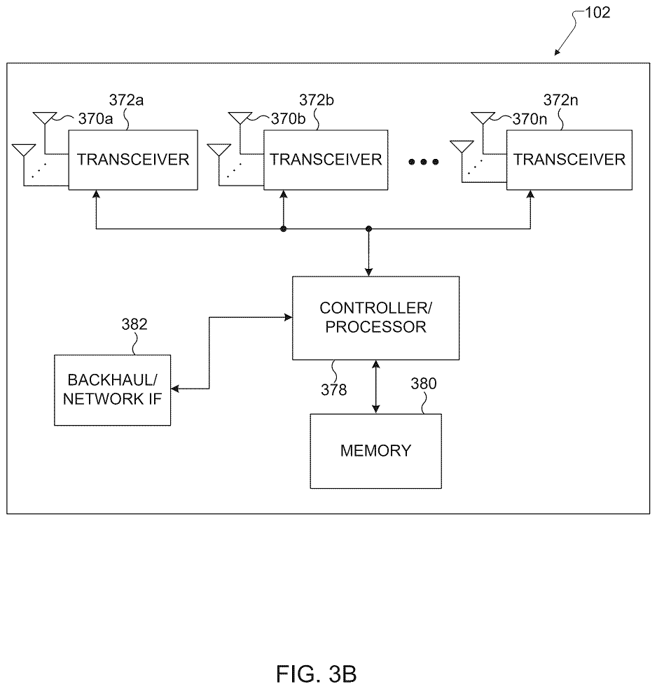

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for conditional LTM TA timer handling as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support conditional LTM TA timer handling as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot) =0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

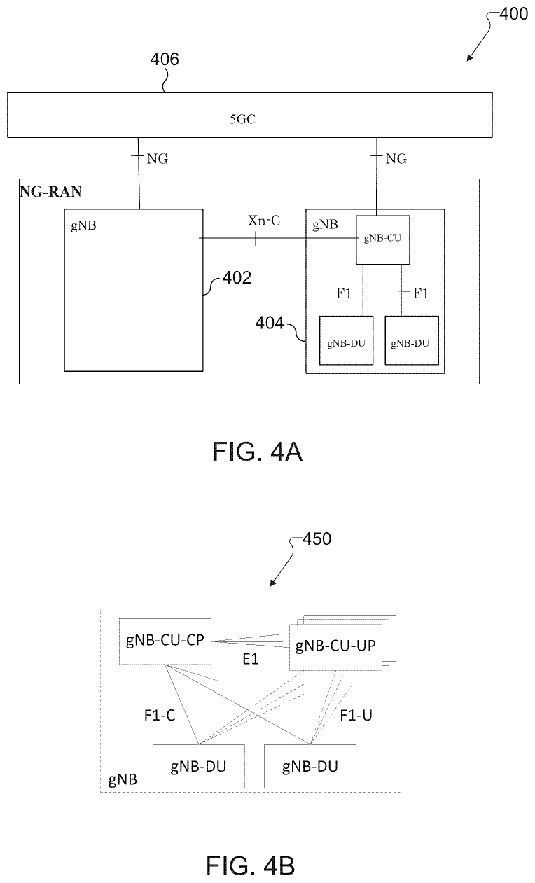

FIG. 4A illustrates an example next generation radio access network (NG-RAN) overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

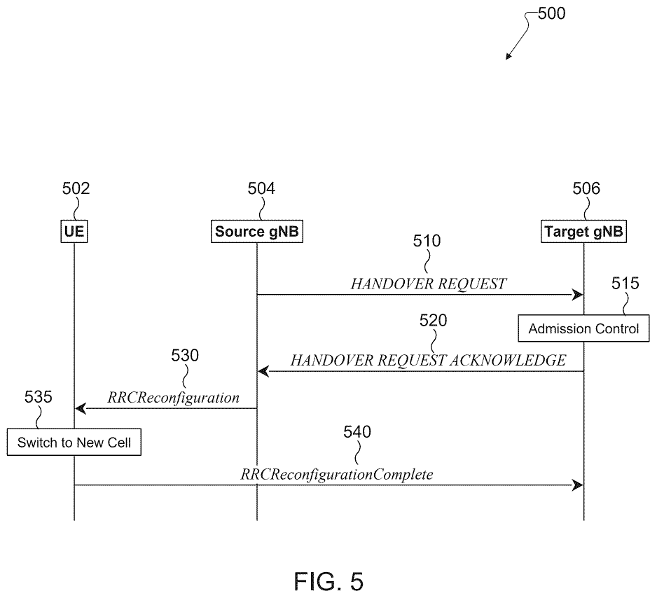

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 5.

FIG. 5 illustrates example signaling procedures 500 for inter-gNB handover according to embodiments of the present disclosure. An embodiment of the signaling procedures illustrated in FIG. 5 are for illustration only. One or more of the components illustrated in FIG. 5 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 5, source gNB 504 initiates handover and issues a HANDOVER REQUEST 510 over an Xn interface to a target gNB 506. Target gNB performs admission control at step 515 and provides a new RRC configuration as part of a HANDOVER REQUEST ACKNOWLEDGE 520. Source gNB 504 provides the RRC configuration to UE 502 by forwarding the RRCReconfiguration message 530 received in the HANDOVER REQUEST ACKNOWLEDGE 520. The RRCReconfiguration message 530 includes at least cell ID and all information required to access the target cell so that the UE 502 can access the target cell without reading system information. For some cases, the information required for contention-based and contention-free random access can be included in RRCReconfiguration message 530. The access information to the target cell may include beam specific information, if any. At step 535, UE 502 moves the RRC connection to target gNB 506 and replies with the RRCReconfigurationComplete message 540. The example of FIG. 5 may be referred to as a network controlled or network initiated handover procedure.

Although FIG. 5 illustrates one example of signaling procedures 500 for inter-gNB handover, various changes may be made to FIG. 5. For example, while shown as a series of steps, various steps in FIG. 5 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer one (L1)/layer two (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early timing advance (TA) acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. If the UE does not receive the configured grant in the RRC signaling, the UE monitors PDCCH for dynamic scheduling from the target cell upon LTM cell switch. Before RACH-less LTM procedure completion, the UE shall not trigger random access procedure if it does not have a valid PUCCH resource for triggered SRs.

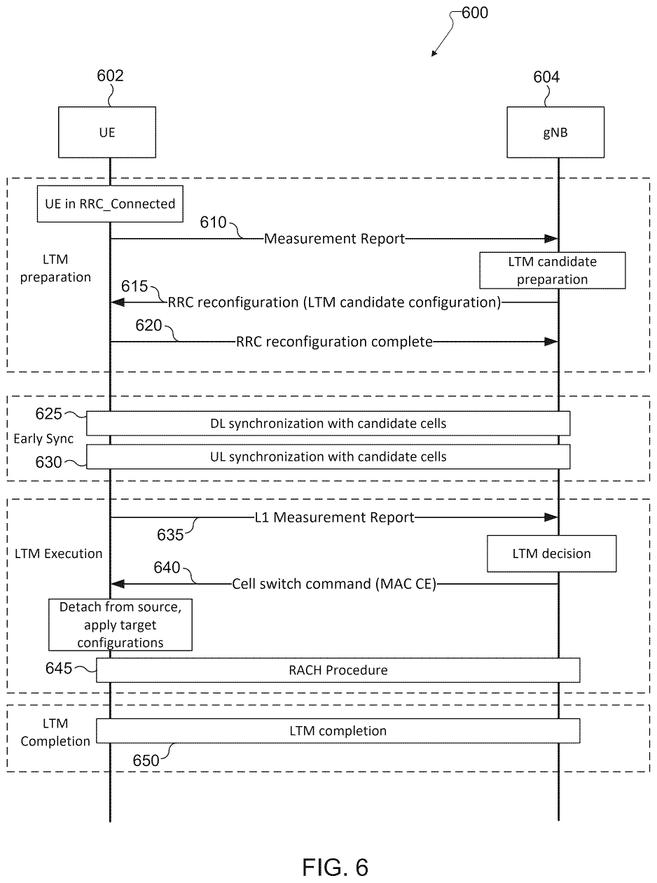

FIG. 6 illustrates an example procedure 600 for LTM according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 6, procedure 600 begins at step 610. At step 610, UE 602 sends a MeasurementReport message to gNB 604. gNB 604 then decides to configure LTM and initiates candidate cell(s) preparation.

At step 615, gNB 604 transmits an RRCReconfiguration message to UE 602 including the LTM candidate cell configurations of one or multiple candidate cells.

At step 620, UE 602 stores the LTM candidate cell configurations and transmits an RRCReconfigurationComplete message to gNB 604.

At step 625, UE 602 may perform DL synchronization with candidate cell(s) before receiving a cell switch command.

At step 630, if requested by the network, UE 602 performs early TA acquisition with candidate cell(s) before receiving the cell switch command. This is done via contention free random access (CFRA) triggered by a PDCCH order from the source cell, following which UE 602 sends a preamble towards the indicated candidate cell. In order to minimize the data interruption of the source cell due to the CFRA towards the candidate cell(s), UE 602 doesn't receive a RAR for the purpose of TA value acquisition and the TA value of the candidate cell is indicated in the cell switch command. UE 602 doesn't maintain the TA timer for the candidate cell and relies on network implementation to guarantee the TA validity.

At step 635, UE 602 performs L1 measurements on the configured candidate cell(s) and transmits L1 measurement reports to the gNB.

At step 640, gNB 604 decides to execute cell switch to a target cell and transmits a MAC CE triggering cell switch by including the candidate configuration index of the target cell. UE 602 switches to the target cell and applies the configuration indicated by the candidate configuration index.

At step 645, UE 602 performs a random access procedure towards the target cell if UE does not have valid TA of the target cell.

At step 650, UE 602 completes the LTM cell switch procedure by sending a RRCReconfigurationComplete message to the target cell. If UE 602 has performed a RA procedure in step 645, UE 602 considers that the LTM execution is successfully completed when the random access procedure is successfully completed. For RACH-less LTM, UE 602 considers that the LTM execution is successfully completed when the UE determines that the network has successfully received its first UL data. UE 602 determines successful reception of its first UL data by receiving a PDCCH addressing UE 602's C-RNTI in the target cell, which schedules a new transmission following the first UL data.

For LTM, the network may indicate one or more L1 measurement based events based on which UE 602 may initiate LTM execution to a candidate LTM cell without receiving a cell switch command from gNB 604. This procedure may be referred as conditional LTM or UE initiated LTM.

Although FIG. 6 illustrates one example procedure 600 for LTM, various changes may be made to FIG. 6. For example, while shown as a series of steps, various steps in FIG. 6 could overlap, occur in parallel, occur in a different order, occur any number of times, be omitted, or replaced by other steps.

As noted above, in the next generation wireless communication system (e.g., 5G, beyond 5G, 6G), the network may request the UE to perform early TA acquisition of a candidate cell before a cell switch. The advantage here is that UE need not perform a random access procedure when a cell switch to a candidate cell is performed. RACH less cell switching reduces data interruption. The early TA acquisition is triggered by a PDCCH order that indicates one of the LTM candidate cells.

To perform early TA acquisition, the UE initiates a random access procedure. The UE transmits a random access preamble to the indicated LTM candidate cell using the early UL synchronization configuration of that candidate cell. Upon transmission of the random access preamble, the random access procedure is considered completed. The candidate cell determines the TA value based on the received random access preamble. The candidate cell or DU of the candidate cell sends the estimated TA to the gNB/DU (or source gNB/DU) of the serving cell. If the candidate cell is configured for UE initiated LTM cell switch, the gNB/DU (or source gNB/DU) of the serving cell may send the TA value in a MAC CE to the UE. The MAC CE indicates the LTM candidate cell identity and TA value. The UE stores the received TA for the indicated candidate LTM cell.

For early TA acquisition, an ltm-Candidate-TimeAlignmentTimer for an LTM candidate cell can be signaled (e.g., in early an UL synchronization configuration or LTM configuration) by the gNB for the delivered TA. Afterward, the UE starts an ltm-Candidate-TimeAlignmentTimer for the LTM candidate cell indicated in the MAC CE. This ltm-Candidate-TimeAlignmentTimer is different from TimeAlignmentTimer. TimeAlignmentTimer is a timer which the UE maintains per timing advance group (TAG). Each serving cell is associated with a TAG and multiple serving cells can be associated with the same TAG. ltm-Candidate-TimeAlignmentTimer is a timer which the UE maintains per LTM candidate cell. In case the LTM candidate cell belongs to two TAGs, an ltm-Candidate-TimeAlignmentTimer is maintained separately for each TAG of the LTM candidate cell.

While the ltm-Candidate-TimeAlignmentTimer is running for a cell (e.g., Cell “A”), several events can occur, such as: a Conditional LTM execution condition being met for the Cell A, the UE receiving an LTM cell switch command MAC CE indicating Cell A as a target and TA is included in this MAC CE, the UE may receive and LTM cell switch command MAC CE indicating Cell A as a target and TA is not included in this MAC CE, an RRC connection may be released, an RRC connection may re-established, etc. In case of these events, handling of ltm-Candidate-TimeAlignmentTimer is desirable. In some cases, it may be beneficial to continue running the ltm-Candidate-TimeAlignmentTimer, whereas in other cases it may be beneficial to stop the running ltm-Candidate-TimeAlignmentTimer.

While the ltm-Candidate-TimeAlignmentTimer is running for a cell (say Cell “A”), the UE may receive an RRC Reconfiguration message from the serving cell (or source cell), wherein the RRC Reconfiguration message may include an LTM configuration which may be different from the LTM configuration previously received by the UE. However, it is presently undefined how the UE handles an ltm-Candidate-TimeAlignmentTimer for the one or more LTM candidate cells for conditional handover which are not included in the latest received RRC Reconfiguration message (or are included but not for conditional LTM), since the LTM candidate cell is identified by an LTM configuration identity which may point to a new LTM candidate cell in the latest received RRC Reconfiguration message.

Various embodiments of the present disclosure provide mechanisms for a UE to handle an ltm-Candidate-TimeAlignmentTimer.

In some wireless network designs, an LTM cell switch from a Cell 1 to a Cell 2 is supported, wherein Cell 1 and Cell 2 belongs to same CU. Security keys are not changed/updated during the LTM cell switch from Cell 1 to Cell 2.

For a network controlled handover according to some wireless network designs (where the network sends a handover command as in FIG. 5) or conditional handover (CHO), whether to update security keys is indicated by signaling a masterKeyUpdate IE in an RRCReconfiguration message. The masterKeyUpdate includes a nextHopChainingCount (NCC). If the NCC received is not identical to an NCC corresponding to the current security key KgNB, the UE derives a security key KgNB* using a next hop (NH) corresponding to the received NCC. This is also referred as vertical key derivation. If the NCC received is identical to the NCC corresponding to the current security key KgNB, the UE derives the security key KgNB* using KgNB. The UE then derives RRC and user plane encryption and integrity protection keys from KgNB* which are used in a new cell (i.e., a target cell).

For inter CU LTM, a masterKeyUpdate/nextHopChainingCount (NCC) can be signaled in an LTM cell switch command MAC CE and/or the NCC can be signaled by an RRCReconfiguration message. The UE needs to know whether the network supports configuration of NCC for inter CU LTM using an RRCReconfiguration message and/or LTM cell switch command MAC CE so that the UE can accordingly receive the NCC and apply the NCC for inter CU LTM. If both approaches are supported, the UE needs to determine whether to apply the NCC from the RRCReconfiguration message or the LTM cell switch command MAC CE for inter CU LTM. Various embodiments of the present disclosure provide mechanisms for a UE to apply an NCC from an RRCReconfiguration message or an LTM cell switch command MAC CE for inter CU LTM.

As noted above, various embodiments of the present disclosure provide mechanisms for a UE to handle an ltm-Candidate-TimeAlignmentTimer.

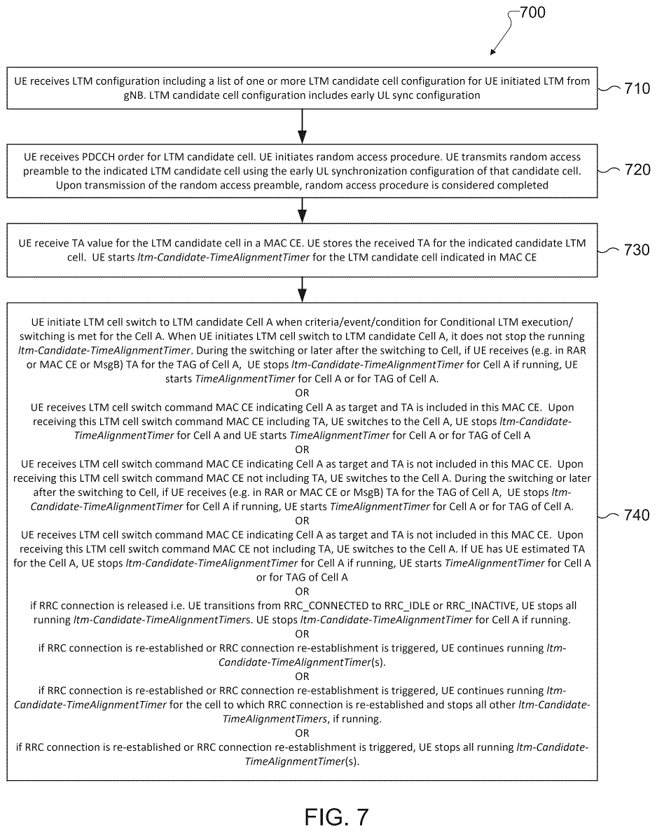

FIG. 7 illustrates an example procedure for ltm-Candidate-TimeAlignmentTimer handling 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for ltm-Candidate-TimeAlignmentTimer handling could be used without departing from the scope of this disclosure.

In the example of FIG. 7, the procedure 700 begins at operation 710. At operation 710, a UE (such as UE 116 of FIG. 1) receives an LTM configuration from a gNB (such as gNB 102 of FIG. 1). For example, in some embodiments, the UE may receive an RRCReconfiguration message that includes the LTM configuration. The LTM configuration includes an LTM candidate configuration for one or more LTM candidate cells. Each LTM candidate configuration includes an early UL synchronization configuration for a normal uplink (NUL) and/or a supplementary uplink (SUL). The UE stores the received configuration and, in some embodiments, transmits an RRCReconfigurationComplete message to the gNB.

Upon receiving the LTM configuration, the UE identifies one or more LTM candidate cells for which UE initiated LTM cell switch is allowed/enabled. The UE then identifies criteria/events/conditions for UE initiated LTM cell switch, and evaluates the identified LTM candidate cells for which UE initiated LTM cell switch is allowed/enabled based on the identified criteria/events/conditions.

At operation 720, the UE receives a PDCCH order from the source cell (serving cell). The PDCCH order indicates one of the LTM candidate cells (e.g., Cell “A”). The UE then initiates a random access procedure, and transmits a random access preamble to the indicated LTM candidate cell using the early UL synchronization configuration of that candidate cell. Upon transmission of the random access preamble, the random access procedure is considered completed. The candidate cell determines the TA value based on the received random access preamble. The, the candidate cell (or the DU of the candidate cell) sends the estimated TA to the gNB/DU (or source gNB/DU) of the serving cell. If the candidate cell is configured for UE initiated LTM cell switch, the gNB/DU (or source gNB/DU) of the serving cell may send the TA value in a MAC CE to the UE. The MAC CE indicates LTM candidate cell identity and TA value.

At operation 730, the UE stores the received TA for the indicated candidate LTM cell, and starts an ltm-Candidate-TimeAlignmentTimer for the LTM candidate cell indicated in the MAC CE. In some embodiments, the ltm-Candidate-TimeAlignmentTimer for the LTM candidate cell can be signaled (e.g., in an early UL synchronization configuration or LTM configuration) by the gNB for the delivered TA.

In some embodiments, at operation 740, the UE initiates an LTM cell switch to the LTM candidate cell (i.e., Cell A) when a criterion/event/condition for conditional LTM execution/switching is met for the Cell A. When the UE initiates the LTM cell switch to the LTM candidate Cell A, the UE does not stop the running ltm-Candidate-TimeAlignmentTimer for Cell A. The UE applies the stored TA of Cell A for UL transmission. During the switching or later after the switching to Cell A, if the UE receives (e.g., in a RAR or MAC CE or MsgB) TA for the TAG of Cell A, the UE stops the ltm-Candidate-TimeAlignmentTimer for Cell A if running, and the UE starts a TimeAlignmentTimer for Cell A or for the TAG of Cell A.

In some embodiments, the UE initiates an LTM cell switch to an LTM candidate Cell B when a criterion/event/condition for conditional LTM execution/switching is met for the Cell B. When the UE initiates the LTM cell switch to the LTM candidate Cell B, the UE does not stop the running ltm-Candidate-TimeAlignmentTimer for the LTM candidate cell B. Alternatively, in some embodiments, when the UE initiates the LTM cell switch to the LTM candidate Cell B, the stops the running ltm-Candidate-TimeAlignmentTimer for the LTM candidate cell B or for LTM candidate cells other than Cell B.

In some embodiments, the UE hands over (in a network initiated HO or conditional HO) to a target cell which is the LTM candidate Cell A. When the UE hands over to the LTM candidate Cell A, the UE stops the running ltm-Candidate-TimeAlignmentTimer for Cell A.

Alternatively, in some embodiments, at operation 740, the UE receives an LTM cell switch command MAC CE indicating Cell A as the target and TA is included in this MAC CE. Upon receiving this LTM cell switch command MAC CE including TA, the UE switches to the Cell A, the UE stops the ltm-Candidate-TimeAlignmentTimer for Cell A, and the UE starts a TimeAlignmentTimer for Cell A or for the TAG of Cell A.

Alternatively, in some embodiments, at operation 740, the UE receives an LTM cell switch command MAC CE indicating Cell A as the target and TA is not included in this MAC CE. Upon receiving this LTM cell switch command MAC CE not including TA, the UE switches to the Cell A. During the switching or later after the switching to Cell A, if the UE receives (e.g., in a RAR or MAC CE or MsgB) a TA for the TAG of Cell A, the UE stops the ltm-Candidate-TimeAlignmentTimer for Cell A if running, and the UE starts a TimeAlignmentTimer for Cell A or for the TAG of Cell A.

Alternatively, in some embodiments, at operation 740, the UE receives an LTM cell switch command MAC CE indicating Cell A as the target and TA is not included in this MAC CE. Upon receiving this LTM cell switch command MAC CE not including TA, the UE switches to the Cell A. If the UE has UE estimated TA for the Cell A, the UE stops the ltm-Candidate-TimeAlignmentTimer for Cell A if running, and the UE starts a TimeAlignmentTimer for Cell A or for the TAG of Cell A.

Alternatively, in some embodiments, at operation 740, if an RRC connection is released (i.e., the UE transitions from RRC connected (RRC_CONNECTED) state to and RRC idle (RRC_IDLE) or RRC inactive (RRC_INACTIVE) state), the UE stops all running ltm-Candidate-TimeAlignmentTimers, including the ltm-Candidate-TimeAlignmentTimer for Cell A if it is running.

Alternatively, in some embodiments, at operation 740, if an RRC connection is re-established or RRC connection re-establishment is triggered, the UE continues running ltm-Candidate-TimeAlignmentTimer(s).

Alternatively, in some embodiments, at operation 740, if an RRC connection is re-established or RRC connection re-establishment is triggered, the UE continues running ltm-Candidate-TimeAlignmentTimer for the cell to which the RRC connection is re-established and stops all other ltm-Candidate-TimeAlignmentTimers, if running.

Alternatively, in some embodiments, at operation 740, if an RRC connection is re-established or RRC connection re-establishment is triggered, the UE stops all running ltm-Candidate-TimeAlignmentTimer(s).

Although FIG. 7 illustrates one example procedure for ltm-Candidate-TimeAlignmentTimer handling 700, various changes may be made to FIG. 7. For example, while shown as a series of operations, various operations in FIG. 7 could overlap, occur in parallel, occur in a different order, occur any number of times, be omitted, or replaced by other operations.

In some embodiments, when a conditional LTM cell switch procedure is triggered for an LTM candidate cell, and the ltm-Candidate-TimeAlignmentTimer associated with the LTM candidate cell is running, the UE (i) applies the stored TA value associated with the LTM candidate cell for the PTAG, (ii) starts the timeAlignmentTimer associated with the PTAG (or starts the timeAlignmentTimer associated with the PTAG with a timer value equal to the remaining value of the running ltm-Candidate-TimeAlignmentTimer), and (iii) stops the ltm-Candidate-TimeAlignmentTimer.

In some embodiments, when a conditional LTM cell switch procedure is triggered for an LTM candidate cell, and the ltm-Candidate-TimeAlignmentTimer associated with the LTM candidate cell is running, the UE applies the stored TA value associated with the LTM candidate cell for the PTAG, and the ltmCandidateTimeAlignmentTimer is considered as the timeAlignmentTimer associated with the PTAG.

In some embodiments, when the timeAlignmentTimer(s) associated with all PTAG(s) and the ltm-Candidate-TimeAlignmentTimer for the SpCell is not running, a configured grant-small data transmission (CG-SDT) procedure is not ongoing and a positioning SRS transmission in an RRC_INACTIVE state is not ongoing, the MAC entity shall not perform any uplink transmission on any serving cell except the random access preamble and MsgA transmission on the SpCell.

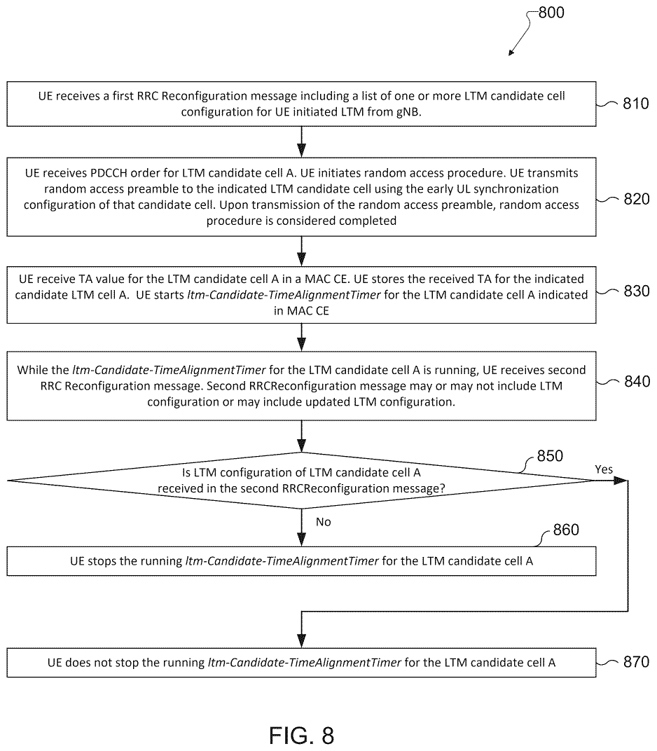

FIG. 8 illustrates another example procedure for ltm-Candidate-TimeAlignmentTimer handling 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for ltm-Candidate-TimeAlignmentTimer handling could be used without departing from the scope of this disclosure.

In the example of FIG. 8, the procedure 800 begins at operation 810. At operation 810, a UE (such as UE 116 of FIG. 1) receives an LTM configuration from a gNB (such as gNB 102 of FIG. 1). For example, in some embodiments, the UE may receive an RRCReconfiguration message that includes the LTM configuration. The LTM configuration includes an LTM candidate configuration for one or more LTM candidate cells. Each LTM candidate configuration includes an early UL synchronization configuration for a normal uplink (NUL) and/or a supplementary uplink (SUL). The UE stores the received configuration and, in some embodiments, transmits an RRCReconfigurationComplete message to the gNB.

Upon receiving the LTM configuration, the UE identifies one or more LTM candidate cells for which UE initiated LTM cell switch is allowed/enabled. The UE then identifies criteria/events/conditions for UE initiated LTM cell switch, and evaluates the identified LTM candidate cells for which UE initiated LTM cell switch is allowed/enabled based on the identified criteria/events/conditions.

At operation 820, the UE receives a PDCCH order from the source cell (serving cell). The PDCCH order indicates one of the LTM candidate cells (e.g., Cell “A”). The UE then initiates a random access procedure, and transmits a random access preamble to the indicated LTM candidate cell using the early UL synchronization configuration of that candidate cell. Upon transmission of the random access preamble, the random access procedure is considered completed. The candidate cell determines the TA value based on the received random access preamble. The, the candidate cell (or the DU of the candidate cell) sends the estimated TA to the gNB/DU (or source gNB/DU) of the serving cell. If the candidate cell is configured for UE initiated LTM cell switch, the gNB/DU (or source gNB/DU) of the serving cell may send the TA value in a MAC CE to the UE. The MAC CE indicates LTM candidate cell identity and TA value.

At operation 830, the UE stores the received TA for the indicated candidate LTM cell (i.e., Cell A), and starts an ltm-Candidate-TimeAlignmentTimer for the LTM candidate cell indicated in the MAC CE. In some embodiments, the ltm-Candidate-TimeAlignmentTimer for the LTM candidate cell can be signaled (e.g., in an early UL synchronization configuration or LTM configuration) by the gNB for the delivered TA.

At operation 840, while the ltm-Candidate-TimeAlignmentTimer for the LTM candidate cell A is running, the UE receives a second RRCReconfiguration message. The second RRCReconfiguration message may or may not include LTM configuration.

In some embodiments, at operation 850, the UE checks if the LTM configuration (which may be UE initiated or may be non-UE initiated) of LTM candidate cell A is received in the second RRCReconfiguration message. If the LTM configuration of LTM candidate cell A is not received in the second RRCReconfiguration message, then at operation 860 the UE stops the running ltm-Candidate-TimeAlignmentTimer for the LTM candidate cell A, and in cases where the LTM candidate cell A is associated with two TAGs, the UE stops the ltm-Candidate-TimeAlignmentTimer associated with each TAG, if running. Otherwise, if the LTM configuration of LTM candidate cell A is received in the second RRCReconfiguration message, then at operation 870 the UE continues (i.e., does not stop) the running ltm-Candidate-TimeAlignmentTimer for the LTM candidate cell A, and in cases where the LTM candidate cell A is associated with two TAGs, the UE continues (i.e., does not stop) the ltm-Candidate-TimeAlignmentTimer associated with each TAG, if running.

Alternatively, in some embodiments, at operation 850, the UE checks if the UE initiated LTM configuration of LTM candidate cell A is received in the second RRCReconfiguration message. If the UE initiated LTM configuration of LTM candidate cell A is not received in the second RRCReconfiguration message, then at operation 860 the UE stops the running ltm-Candidate-TimeAlignmentTimer for the LTM candidate cell A, and in cases where the LTM candidate cell A is associated with two TAGs, the UE stops the ltm-Candidate-TimeAlignmentTimer associated with each TAG, if running. Otherwise, if the UE initiated LTM configuration of LTM candidate cell A is received in the second RRCReconfiguration message, at operation 870 the UE continues (i.e., does not stop) the running ltm-Candidate-TimeAlignmentTimer for the LTM candidate cell A, and in cases where the LTM candidate cell A is associated with two TAGs, the UE continues (i.e., does not stops) the ltm-Candidate-TimeAlignmentTimer associated with each TAG, if running. A UE initiated LTM configuration of LTM candidate cell A is considered received in the second RRCReconfiguration message, if the LTM configuration of LTM candidate cell A is received in the second RRCReconfiguration message and it includes a conditional LTM execution condition/configuration.

Alternatively, in some embodiments, at operation 850, the UE checks if the LTM configuration of LTM candidate cell A is received in the second RRCReconfiguration message and it includes conditional LTM execution condition/configuration. If the LTM configuration of LTM candidate cell A is not received in the second RRCReconfiguration message OR if the LTM configuration of LTM candidate cell A is received but it does not include a conditional LTM execution condition/configuration, the at operation 860 the UE stops the running ltm-Candidate-TimeAlignmentTimer for the LTM candidate cell A, and in cases where the LTM candidate cell A is associated with two TAGs, the UE stops the ltm-Candidate-TimeAlignmentTimer associated with each TAG, if running. Otherwise, if the LTM configuration of LTM candidate cell A is received in the second RRCReconfiguration message and it includes a conditional LTM execution condition/configuration, the at operation 870 the UE continues (i.e., does not stop) the running ltm-Candidate-TimeAlignmentTimer for the LTM candidate cell A, and in cases where the LTM candidate cell A is associated with two TAGs, the UE continues (i.e., does not stop) the ltm-Candidate-TimeAlignmentTimer associated with each TAG, if running.

Alternatively, in some embodiments, at operation 850 the UE stops all the running ltm-Candidate-TimeAlignmentTimers after receiving the updated LTM configuration in the second RRCReconfiguration message.

Alternatively, in some embodiments, at operation 850 the UE stops the running ltm-Candidate-TimeAlignmentTimer for the LTM candidate cell A if the ltm-Candidate-TimeAlignmentTimer configuration is updated in the second RRCReconfiguration message.

Alternatively, in some embodiments, if the second RRCReconfiguration message is received while the random access procedure initiated by the PDCCH order for an LTM candidate cell A is ongoing and the second RRCReconfiguration message does not include the LTM configuration of LTM candidate cell A, then at operation 850 the UE stops the ongoing random access procedure.

Alternatively, in some embodiments, if the second RRCReconfiguration message is received while the random access procedure initiated by PDCCH order for an LTM candidate cell A is ongoing and second RRCReconfiguration message does not include the UE initiated LTM configuration of LTM candidate cell A, then at operation 850 the UE stops the ongoing random access procedure.

Alternatively, in some embodiments, (i) if the second RRCReconfiguration message is received while the random access procedure initiated by PDCCH order for an LTM candidate cell A is ongoing, and (ii) if the LTM configuration of LTM candidate cell A is not received in the second RRCReconfiguration message, or if the LTM configuration of LTM candidate cell A is received but it does not include conditional LTM execution condition/configuration, then at operation 850 the UE stops the ongoing random access procedure.

Alternatively, in some embodiments, if the second RRCReconfiguration message is received while the random access procedure initiated by PDCCH order for an LTM candidate cell A is ongoing and an early uplink sync configuration (RA configuration for early AT) is updated/changed, the UE stops the ongoing random access procedure.

Although FIG. 8 illustrates one example procedure for ltm-Candidate-TimeAlignmentTimer handling 800, various changes may be made to FIG. 8. For example, while shown as a series of operations, various operations in FIG. 8 could overlap, occur in parallel, occur in a different order, occur any number of times, be omitted, or replaced by other operations.

As noted above, various embodiments of the present disclosure provide mechanisms for a UE to apply an NCC from an RRCReconfiguration message or an LTM cell switch command MAC CE for inter CU LTM.

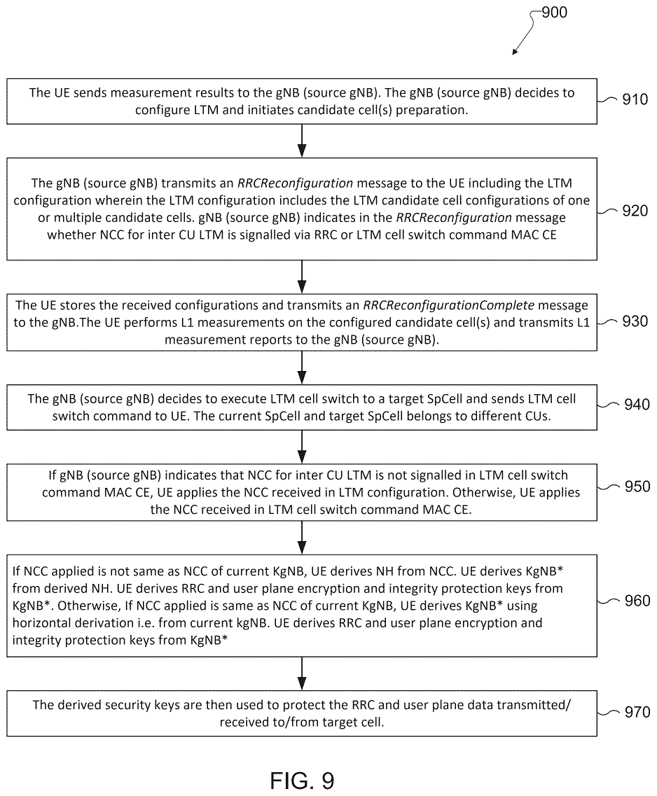

FIG. 9 illustrates an example LTM based mobility procedure 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of an LTM based mobility procedure could be used without departing from the scope of this disclosure.

In the example of FIG. 9, the procedure 900 begins at operation 910. At operation 910, a UE (such as UE 116 of FIG. 1) sends measurement results to a gNB (source gNB) (such as gNB 102 of FIG. 1). The gNB (source gNB) decides to configure LTM and initiates candidate cell(s) preparation.

At operation 920, the gNB (source gNB) transmits an RRCReconfiguration message to the UE including the LTM configuration. The LTM configuration includes LTM candidate cell configurations of one or multiple candidate cells. In some embodiments, the gNB (source gNB) indicates in an RRCReconfiguration message whether NCC for inter CU LTM is signaled in an RRC message (e.g., RRCReconfiguration [in the LTM configuration]) or in an LTM cell switch command MAC CE. Alternatively, in some embodiments, the gNB (source gNB) indicates in an RRCReconfiguration message whether or not NCC for inter CU LTM is signaled in an LTM cell switch command MAC CE. In some embodiments, presence of NCC in RRCReconfiguration (in the LTM configuration) is an implicit indication that NCC is not signaled in an LTM cell switch command MAC CE. If the gNB (source gNB) indicates that NCC for inter CU LTM is not signaled in the LTM cell switch command MAC CE, NCC for inter CU LTM is signaled in the RRC message (e.g., RRCReconfiguration [in the LTM configuration]).

If the gNB (source gNB) has an unused next hop (NH) to derive KgNB*, the gNB sends an NCC corresponding to the unused NH for inter CU LTM, which is signaled in an RRC message (e.g., RRCReconfiguration [in the LTM configuration]).

If the gNB (source gNB) does not have an unused NH to derive KgNB*, the gNB sends an NCC corresponding to the current KgNB for inter CU LTM, which is signaled in an RRC message (e.g., RRCReconfiguration [in the LTM configuration]).

(Within a cell group) Upon any handover/cell change/reconfiguration with a security key update, this NCC received in RRCReconfiguration (in the LTM configuration or in an LTM configuration of the cell group) is discarded by the UE and a new NCC will be received in another RRCReconfiguration (in the LTM configuration) after handover/cell change.

An NCC for inter CU LTM is separately configured for the MCG and SCG.

At operation 930, the UE stores the received configurations and transmits an RRCReconfigurationComplete message to the gNB. The UE may perform DL synchronization with candidate cell(s) before receiving the cell switch command. If requested by the network the UE performs early TA acquisition with the candidate cell(s) before receiving the cell switch command. This is done via a CFRA triggered by a PDCCH order from the source cell, following which the UE sends a preamble towards the indicated candidate cell. In order to minimize the data interruption of the source cell due to the CFRA towards the candidate cell(s), the UE doesn't receive a RAR for the purpose of TA value acquisition and the TA value of the candidate cell is indicated in the cell switch command. The UE doesn't maintain the TA timer for the candidate cell and relies on network implementation to guarantee the TA validity. The UE then performs L1 measurements on the configured candidate cell(s) and transmits L1 measurement reports to the gNB (source gNB).

At operation 940, the gNB (source gNB) decides to execute LTM cell switch to a target SpCell and sends an LTM cell switch command to UE. The current SpCell and target SpCell belongs to different CUs. For inter CU LTM, the network can indicate (e.g., an NCC) in the LTM cell switch command to update security keys in a cell switch command or the network can include a security update ID in the LTM candidate cell configuration and a security update ID in the LTM configuration for the current serving cell. If a security update ID for the current serving cell is different from a security update ID in the LTM candidate cell configuration of target cell, the UE updates security keys. Otherwise, the UE does not update security keys. If security keys are to be updated, the UE determines the NCC as follows:

In some embodiments, at operation 950, if the gNB (source gNB) indicates that NCC for inter CU LTM is not signaled in an LTM cell switch command MAC CE, the UE applies the NCC received in the RRC message (e.g., RRCReconfiguration [in the LTM configuration]). The NCC may be separately configured for the MCG and the SCG, and the UE selects the NCC corresponding to the cell group for which inter CU LTM cell switch is triggered. Otherwise, the UE applies the NCC received in the LTM cell switch command MAC CE.

Alternatively, in some embodiments, at operation 950, if the gNB (source gNB) indicates that NCC for inter CU LTM is signaled in an RRC message, the UE applies the NCC received in the RRC message (e.g., RRCReconfiguration [in the LTM configuration]). The NCC may be separately configured for the MCG and the SCG, and the UE selects the NCC corresponding to the cell group for which inter CU LTM cell switch is triggered. Otherwise, the UE applies the NCC received in the LTM cell switch command MAC CE.

Alternatively, in some embodiments, at operation 950, if an NCC is received in RRCReconfiguration (i.e., in the LTM configuration for inter CU LTM), the UE applies this NCC for inter CU LTM. Otherwise, the UE applies the NCC received in the LTM cell switch command MAC CE.

Alternatively, in some embodiments, at operation 950, if an NCC is received in an LTM cell switch command MAC CE, the UE applies the NCC received in the LTM cell switch command MAC CE. Otherwise, if the NCC is received in RRCReconfiguration (i.e., in an LTM configuration for inter CU LTM), the UE applies this NCC. NCC may be separately configured for MCG and SCG, UE select NCC corresponding to cell group for which inter CU LTM cell switch is triggered.

In some embodiments, if an NCC for inter CU LTM is received via both RRC and an LTM cell switch command MAC CE, the UE applies the NCC received in LTM cell switch command MAC CE.

At operation 960, if the NCC applied is not the same as the NCC of a current KgNB, the UE derives an NH from the NCC, derives KgNB* from derived NH, and derives RRC and user plane encryption and integrity protection keys from KgNB*. Otherwise, if the NCC applied is the same as the NCCC of a current KgNB, the UE derives KgNB* using horizontal derivation (i.e., from the current kgNB), and derives RRC and user plane encryption and integrity protection keys from KgNB*.

At operation 970, the derived security keys are then used to protect the RRC and user plane data transmitted/received to/from target cell.

Although FIG. 9 illustrates one example LTM based mobility procedure 900, various changes may be made to FIG. 9. For example, while shown as a series of operations, various operations in FIG. 9 could overlap, occur in parallel, occur in a different order, occur any number of times, be omitted, or replaced by other operations.

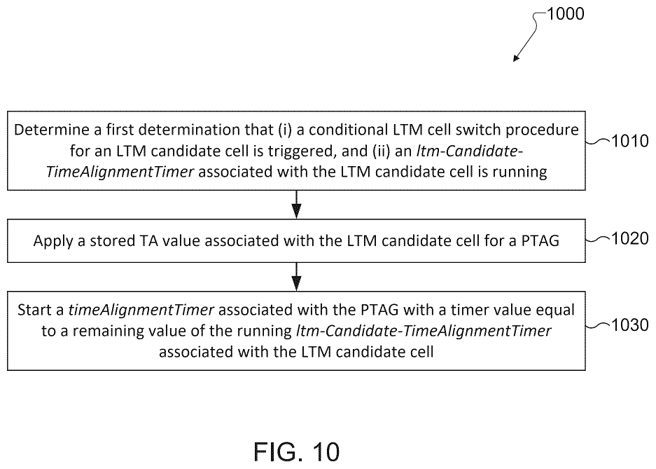

FIG. 10 illustrates an example method for conditional LTM TA timer handling 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for conditional LTM TA timer handling could be used without departing from the scope of this disclosure.

In the example of FIG. 10, the method 1000 begins at operation 1010. At operation 1010, a UE (such as UE 116 of FIG. 1) determines a first determination that (i) a conditional LTM cell switch procedure for an LTM candidate cell is triggered, and (ii) an ltm-Candidate-TimeAlignmentTimer associated with the LTM candidate cell is running. In response to the first determination, the UE performs steps 1020 through 1030.

At step 1020, the UE applies a stored TA value associated with the LTM candidate cell for a PTAG.

At step 1030, the UE starts a timeAlignmentTimer associated with the PTAG with a timer value equal to a remaining value of the running ltm-Candidate-TimeAlignmentTimer associated with the LTM candidate cell.

In some embodiments, the ltm-Candidate-TimeAlignmentTimer associated with the LTM candidate cell is not stopped upon the conditional LTM cell switch procedure for the LTM candidate cell being triggered.

In some embodiments, the UE may transition from an RRC_CONNECTED state to an RRC_IDL start or an RRC_INACTIVE state. In response to the transition from the RRC_CONNECTED state to the RRC_IDLE or RRC_INACTIVE state, the UE may stop any running ltm-Candidate-TimeAlignmentTimers including the ltm-Candidate-TimeAlignmentTimer associated with the LTM candidate cell.

In some embodiments, the UE may determine a second determination that an RRC connection is re-established or that an RRC connection re-establishment is triggered. In response to the second determination, the UE may stop any running ltm-Candidate-TimeAlignmentTimers including the ltm-Candidate-TimeAlignmentTimer associated with the LTM candidate cell.

In some embodiments, the UE may receive the TA value associated with the LTM candidate cell, and in response to receiving the TA value associated with the LTM candidate cell, start the ltm-Candidate-TimeAlignmentTimer associated with the LTM candidate cell.

In some embodiments, before determining the first determination, the UE may, receive a first RRC reconfiguration message including an LTM candidate configuration for the LTM candidate cell. In embodiments such as these, while the ltm-Candidate-TimeAlignmentTimer associated with the LTM candidate cell is running, the UE may receive a second RRC reconfiguration message. The UE may then determine whether the second RRC reconfiguration message includes an LTM candidate configuration for the LTM candidate cell, and in response to a determination that the second RRC reconfiguration message does not include an LTM candidate configuration for the LTM candidate cell, stop the ltm-Candidate-TimeAlignmentTimer associated with the LTM candidate cell. In embodiments such as these, the ltm-Candidate-TimeAlignmentTimer associated with the LTM candidate cell is not stopped in response to a determination that the second RRC reconfiguration message includes an LTM candidate configuration for the LTM candidate cell.

In some embodiments, while the ltm-Candidate-TimeAlignmentTimer associated with the LTM candidate cell is running, the UE may receive an RRC reconfiguration message including an updated LTM configuration; and in response to receiving the updated LTM configuration, stop any ltm-Candidate-TimeAlignmentTimers including the ltm-Candidate-TimeAlignmentTimer associated with the LTM candidate cell.

In some embodiments, while the ltm-Candidate-TimeAlignmentTimer associated with the LTM candidate cell is running, the UE may receive an RRC reconfiguration message including an updated ltm-Candidate-TimeAlignmentTimer configuration, and stop the ltm-Candidate-TimeAlignmentTimer associated with the LTM candidate cell.

In some embodiments, in response to the first determination, the UE may initiate an LTM cell switch the LTM candidate cell, and apply the stored TA value for UL transmission to the LTM candidate cell.

Although FIG. 10 illustrates one example method for conditional LTM TA timer handling 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
determining a first determination that (i) a conditional layer 1 (L1)/layer 2 (L2) triggered mobility (LTM) cell switch procedure for an LTM candidate cell is triggered, and (ii) an LTM candidate time alignment timer (ltm-Candidate-TimeAlignmentTimer) associated with the LTM candidate cell is running; and
in response to the first determination:
applying a stored timing advance (TA) value associated with the LTM candidate cell for a primary timing advance group (PTAG); and
starting a time alignment timer (timeAlignmentTimer) associated with the PTAG with a timer value equal to a remaining value of the running ltm-Candidate-TimeAlignmentTimer associated with the LTM candidate cell.

2. The method of claim 1, wherein the ltm-Candidate-TimeAlignmentTimer associated with the LTM candidate cell is not stopped upon the conditional LTM cell switch procedure for the LTM candidate cell being triggered.

3. The method of claim 1, further comprising:
transitioning from a radio resource control (RRC) connected (RRC_CONNECTED) state to an RRC idle (RRC_IDLE) state or an RRC inactive (RRC_INACTIVE) state; and
in response to the transition from the RRC_CONNECTED state to the RRC_IDLE or RRC_INACTIVE state, stopping any running ltm-Candidate-TimeAlignmentTimers including the ltm-Candidate-TimeAlignmentTimer associated with the LTM candidate cell.

4. The method of claim 1, further comprising:
determining a second determination that a radio resource control (RRC) connection is re-established or that an RRC connection re-establishment is triggered; and
in response to the second determination, stopping any running ltm-Candidate-TimeAlignmentTimers including the ltm-Candidate-TimeAlignmentTimer associated with the LTM candidate cell.

5. The method of claim 1, further comprising:
receiving the TA value associated with the LTM candidate cell; and
in response to receiving the TA value associated with the LTM candidate cell, starting the ltm-Candidate-TimeAlignmentTimer associated with the LTM candidate cell.

6. The method of claim 1, further comprising:
before determining the first determination, receiving a first radio resource control (RRC) reconfiguration message including an LTM candidate configuration for the LTM candidate cell;
while the ltm-Candidate-TimeAlignmentTimer associated with the LTM candidate cell is running, receiving a second RRC reconfiguration message;
determining whether the second RRC reconfiguration message includes an LTM candidate configuration for the LTM candidate cell; and
in response to a determination that the second RRC reconfiguration message does not include an LTM candidate configuration for the LTM candidate cell, stopping the ltm-Candidate-TimeAlignmentTimer associated with the LTM candidate cell.

7. The method of claim 6, wherein the ltm-Candidate-TimeAlignmentTimer associated with the LTM candidate cell is not stopped in response to a determination that the second RRC reconfiguration message includes an LTM candidate configuration for the LTM candidate cell.

8. The method of claim 1, further comprising:
while the ltm-Candidate-TimeAlignmentTimer associated with the LTM candidate cell is running, receiving a radio resource control (RRC) reconfiguration message including an updated LTM configuration; and
in response to receiving the updated LTM configuration, stopping any ltm-Candidate-TimeAlignmentTimers including the ltm-Candidate-TimeAlignmentTimer associated with the LTM candidate cell.

9. The method of claim 1, further comprising:
while the ltm-Candidate-TimeAlignmentTimer associated with the LTM candidate cell is running, receiving a radio resource control (RRC) reconfiguration message including an updated ltm-Candidate-TimeAlignmentTimer configuration; and
in response to receiving the updated ltm-Candidate-TimeAlignmentTimer configuration, stopping the ltm-Candidate-TimeAlignmentTimer associated with the LTM candidate cell.

10. The method of claim 1, further comprising, in response to the first determination:
initiating an LTM cell switch the LTM candidate cell; and
applying the stored TA value for uplink (UL) transmission to the LTM candidate cell.

11. An electronic device comprising:
at least one processor including processing circuitry; and
memory storing instructions, wherein the instructions, when executed by the at least one processor individually or collectively, cause the electronic device to:
determine a first determination that (i) a conditional layer 1 (L1)/layer 2 (L2) triggered mobility (LTM) cell switch procedure for an LTM candidate cell is triggered, and (ii) an LTM candidate time alignment timer (ltm-Candidate-TimeAlignmentTimer) associated with the LTM candidate cell is running; and
in response to the first determination:
apply a stored timing advance (TA) value associated with the LTM candidate cell for a primary timing advance group (PTAG); and
start a time alignment timer (timeAlignmentTimer) associated with the PTAG with a timer value equal to a remaining value of the running ltm-Candidate-TimeAlignmentTimer associated with the LTM candidate cell.

12. The electronic device of claim 11, wherein the ltm-Candidate-TimeAlignmentTimer associated with the LTM candidate cell is not stopped upon the conditional LTM cell switch procedure for the LTM candidate cell being triggered.

13. The electronic device of claim 11, wherein the instructions, when executed by the at least one processor individually or collectively, further cause the electronic device to:
transition from a radio resource control (RRC) connected (RRC_CONNECTED) state to an RRC idle (RRC_IDLE) state or an RRC inactive (RRC_INACTIVE) state; and
in response to the transition from the RRC_CONNECTED state to the RRC_IDLE or RRC_INACTIVE state, stop any running ltm-Candidate-TimeAlignmentTimers including the ltm-Candidate-TimeAlignmentTimer associated with the LTM candidate cell.

14. The electronic device of claim 11, wherein the instructions, when executed by the at least one processor individually or collectively, further cause the electronic device to:
determine a second determination that a radio resource control (RRC) connection is re-established or that an RRC connection re-establishment is triggered; and
in response to the second determination, stop any running ltm-Candidate-TimeAlignmentTimers including the ltm-Candidate-TimeAlignmentTimer associated with the LTM candidate cell.

15. The electronic device of claim 11, wherein the instructions, when executed by the at least one processor individually or collectively, further cause the electronic device to:
receive the TA value associated with the LTM candidate cell; and
in response to receiving the TA value associated with the LTM candidate cell, start the ltm-Candidate-TimeAlignmentTimer associated with the LTM candidate cell.

16. The electronic device of claim 11, wherein the instructions, when executed by the at least one processor individually or collectively, further cause the electronic device to:
before determining the first determination, receive a first radio resource control (RRC) reconfiguration message including an LTM candidate configuration for the LTM candidate cell;
while the ltm-Candidate-TimeAlignmentTimer associated with the LTM candidate cell is running, receive a second RRC reconfiguration message;
determine whether the second RRC reconfiguration message includes an LTM candidate configuration for the LTM candidate cell; and
in response to a determination that the second RRC reconfiguration message does not include an LTM candidate configuration for the LTM candidate cell, stop the ltm-Candidate-TimeAlignmentTimer associated with the LTM candidate cell.

17. The electronic device of claim 16, wherein the ltm-Candidate-TimeAlignmentTimer associated with the LTM candidate cell is not stopped in response to a determination that the second RRC reconfiguration message includes an LTM candidate configuration for the LTM candidate cell.

18. The electronic device of claim 11, wherein the instructions, when executed by the at least one processor individually or collectively, further cause the electronic device to:
while the ltm-Candidate-TimeAlignmentTimer associated with the LTM candidate cell is running, receive a radio resource control (RRC) reconfiguration message including an updated LTM configuration; and
in response to receiving the updated LTM configuration, stop any ltm-Candidate-TimeAlignmentTimers including the ltm-Candidate-TimeAlignmentTimer associated with the LTM candidate cell.

19. The electronic device of claim 11, wherein the instructions, when executed by the at least one processor individually or collectively, further cause the electronic device to:
while the ltm-Candidate-TimeAlignmentTimer associated with the LTM candidate cell is running, receive a radio resource control (RRC) reconfiguration message including an updated ltm-Candidate-TimeAlignmentTimer configuration; and
in response to receiving the updated ltm-Candidate-TimeAlignmentTimer configuration, stop the ltm-Candidate-TimeAlignmentTimer associated with the LTM candidate cell.

20. The electronic device of claim 11, wherein the instructions, when executed by the at least one processor individually or collectively, further cause the electronic device to, in response to the first determination:
initiate an LTM cell switch the LTM candidate cell; and
apply the stored TA value for uplink (UL) transmission to the LTM candidate cell.
